(19) United States
(12) Patent Application Publication
(10) Pub. No.: US 2008/0246414 A1
(43) Pub. Date: Oct. 9, 2008

(54) INDUCTIVE LOAD SENSOR FOR DIMMER CIRCUIT

(76) Inventors: Jian Xu, Windsor (CA); Jeffrey Iott, Monroe, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/696,772

(22) Filed: Apr. 5, 2007

(51) Int. Cl. H05B 41/36

(52) U.S. Cl. 315/291

(57) ABSTRACT

A lighting control circuit includes a dimmer circuit which is provided for an electrical outlet. An inductive load detection circuit is provided for identifying the presence of an inductive load in the electrical outlet. When an inductive load is sensed, dimming of the power directed to the electrical outlet is stopped such that full power is delivered to prevent damage to the load. The inductive load detection circuit identifies the presence of an induction load by sensing voltage spikes. In one embodiment, diodes which have a high impedance at lower voltages, but are largely conductive at higher voltages are utilized to achieve this control.

### BACKGROUND OF THE INVENTION

This application relates to an inductive load sensor for sensing the presence of an inductive load and wherein the sensor looks for voltage spikes.

Electrical systems for providing control of lighting are known. Switches are typically provided for actuating the lights between on and off positions. One known switch is a dimmer switch. A dimmer switch may be actuated to change the intensity of the light across an infinite number of levels. Thus, a user of the space being lighted can adjust the light to a desirable level.

Dimmer switches are also associated with electrical outlets in some applications. As one example, builders will sometimes provide a dimmable electrical outlet as a way of providing dimmable light within a room. This is less expensive than providing a separate lighting circuit and switch. Thus, electrical outlets controlled by a dimmer switch are known.

One problem with such electrical outlets is that there is no way to guarantee a user will only utilize the electrical outlet for a light. As an example, the user may plug in some other load, such as a vacuum cleaner, hair dryer, etc.

When these loads are inductive, there can be some concern if the power delivered to the load is “dimmed” or lowered. Thus, it is known in prior art lighting control circuits to provide a sensor for sensing the presence of an inductive load at an electrical outlet associated with a dimmer switch. In the prior art, the presence of an inductive load is detected by looking at a phase difference. The systems for identifying an inductive load by looking at phase difference are relatively complex and expensive.

### SUMMARY OF THE INVENTION

In a disclosed embodiment of this invention, an inductive load sensor for a dimmer circuit identifies the presence of an inductive load by voltage spikes. If an inductive load is sensed, the sensor stops the dimming of the load such that the power delivered to the inductive load is full “on” when the switch is turned on, or full “off” when the switch is off. In the disclosed embodiment, a voltage being delivered to the load is also placed on a line that is parallel to the load. This parallel path has a high impedance at lower voltages, but becomes conductive at higher voltages. Thus, at lower voltages, the power flows to the load. Once a voltage limit is reached, the parallel path becomes an effective conductive path.

When a voltage spike occurs, the limit for this path is met, and the path will become conductive. At this point, a signal circuit downstream of this path will communicate a signal that an inductive load is sensed. This signal is utilized to turn the dimmer circuit such that it no longer dims the power, but provides it in at full on or full off.

In a disclosed embodiment, the path is provided with at least one diode to achieve the impedance/conductivity feature. This may be a bi-directional zener diode (a transient voltage suppressor, or TVS). There are two TVSs in one embodiment, with one having a low voltage limit, and the other having a much higher voltage limit. The TVS with the low voltage limit is part of the signal circuit, such that when the sum of both limits are met, a voltage from the lower voltage TVS passes downstream through the signal circuit to generate the signal to move the dimmer circuit into a full on or full off state.

These and other features of the present invention can be best understood from the following specification and drawings, the following of which is a brief description.

### BRIEF DESCRIPTION OF THE DRAWINGS

FIG. 1 is a block diagram of an overall lighting control system.

FIG. 2 is a schematic of a dimmer circuit incorporating the present invention.

### DETAILED DESCRIPTION OF THE PREFERRED EMBODIMENT

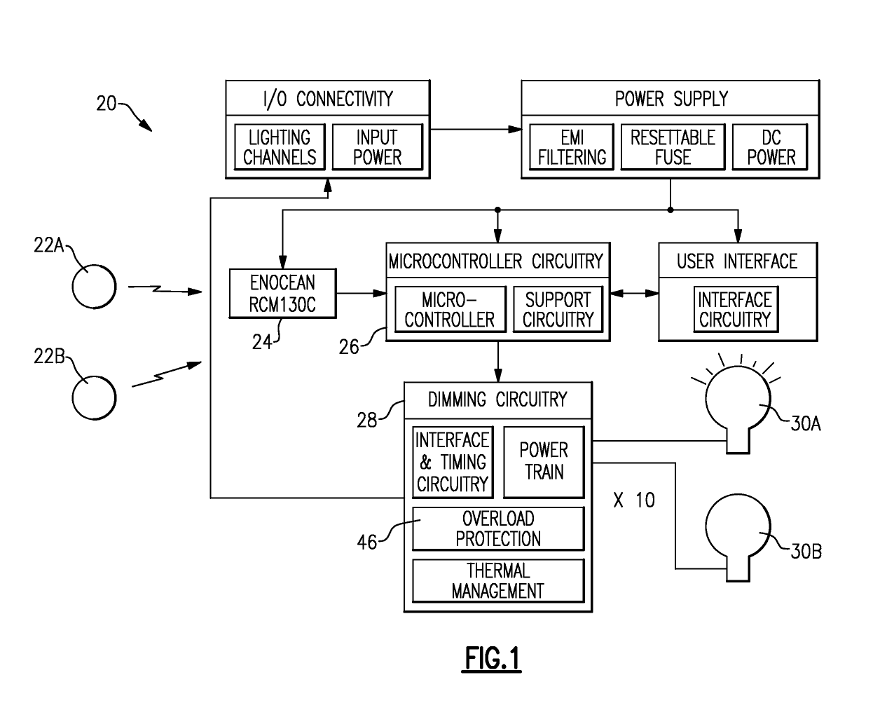

FIG. 1 shows a lighting control circuit 20 for a building. As shown, a plurality of dimmer switches 22A, 22B, etc. communicate through a wireless connection to a multi-channel receiver and controller 24. This receiver may be as available from Enocean, and available for example under its Product No. RCM130C. The use of a wireless receiver and wireless switches are not limiting on this invention, but only mentioned as one possible type of system.

The receiver 24 communicates with a microcontroller 26, which in turn communicates with dimmer circuit 28. The dimmer circuit 28 controls the intensity of several lights 30A, 30B, etc. As shown within the dimmer circuit 28, there is a load protection 46. As mentioned above, one purpose of this load protection is to prevent damage to the load when an inductive load is connected to the circuit.

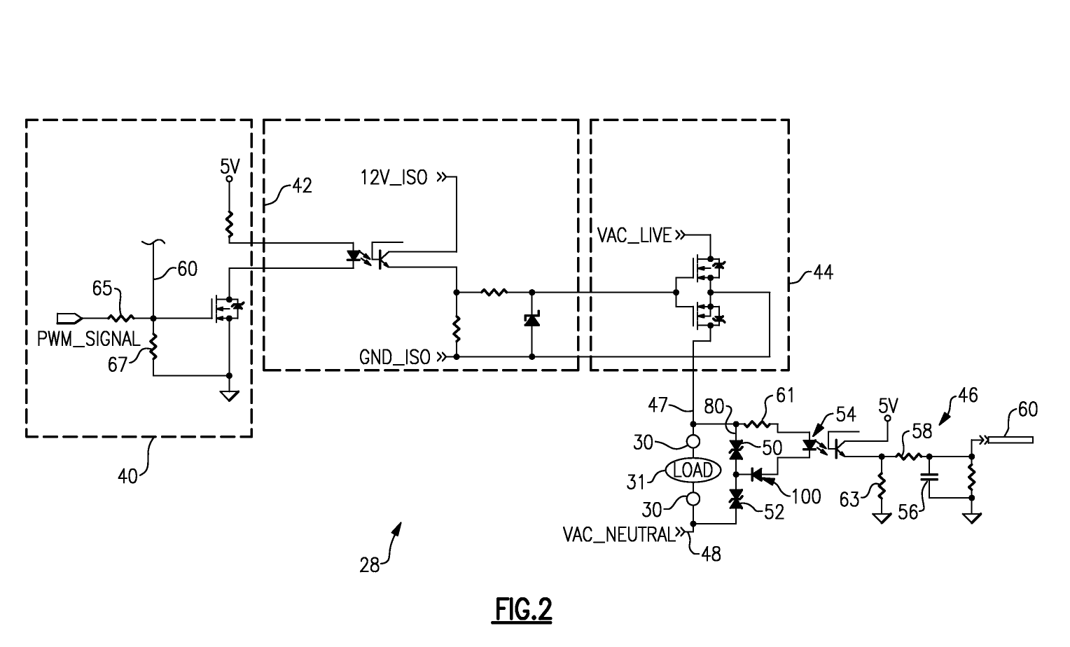

Dimmer circuit 28 is illustrated in FIG. 2. As shown, a microcontroller creates a pulse width modulated signal input at box 40. This signal then communicates to dimmer portion (box 42), and a reverse phase control provided by a pair of MOSFETs (box 44). The circuit elements within boxes 40, 42, and 44 may be replaced by any dimmer circuit. However, in one embodiment, they may be as shown in FIG. 2 and disclosed in co-pending patent application Ser. No. 11/684,834, filed on Mar. 13, 2007, naming Jian Xu, one of the co-inventors of this application, as its inventor, and entitled “Dimming Circuit for Controlling Electrical Power.”

The output 47 of this dimmer circuit passes toward the load 30. As shown, the load 30 here is plugged into the terminals of an electrical outlet 31.

A pair of diodes 50 and 52 are positioned on a line 80 parallel to electrical outlet 31. One of the terminals of the electrical outlet is connected to neutral at 48, as known. The TVS 50 preferably has a high impedance, until a low voltage limit is met. The low voltage limit may be on the order of 5 volts, however, any other voltage may be utilized. The TVS 52 has a high impedance until a much higher voltage limit is met, on the order of hundreds of volts, for example. Again, the specific voltage should not be limiting on this invention, however in one embodiment, it was in the area of 200 volts for 120 volt AC power.

As long as there is no voltage spike received back upstream from the load 30, the dimming of the power directed through output 47 should occur normally.

Line 80 effectively clamps the power. If an inductive load, such as a vacuum cleaner motor, is plugged into the electrical outlet 30, then there will be back EMF pulses, when the load is “dimmed,” which create voltage spikes.

When voltage spikes exceed the sum of the voltage limits of the TVS 50, and TVS 52, a voltage of the value of the TVS 50 will be supplied downstream into the signal circuit, and through an optical coupler 54 and resistor 63. The purpose of the capacitor 56 and resistor 58 is to provide a low pass filtering. Resistor 63, resistor 58 and capacitor 56 together provide time constant control over the output to an output indicator line 60. A resistor 61 is provided to limit the current.

The voltage from the TVS diode 50 is coupled to the resistor 63, and creates a signal on the line 60.

As shown for example in the box 40, the line 60 can communicate back into the intersection of resistors 65 and 67. This is but one way of achieving turning the dimming circuitry off such that full power is delivered to the output 47 when a signal is put on the output line 60. Any other method of using the signal on line 60 to stop dimming may be used.

Notably, FIG. 2 discloses a circuit which would detect positive voltage spikes. It is possible that the load 31 could create both negative and positive spikes. A circuit design with similar functionality could be designed to detect negative spikes, or to detect both positive and negative spikes. In the FIG. 2 circuit, the diode 100 would block the flow of negative spikes. By reversing the direction of the diode 100 and the photo diode in 54, the circuit can be changed to detect negative spikes rather than positive spikes. It is expected that most inductive loads would create both positive and negative spikes, thus the detection of one or the other should be sufficient.

While the present invention discloses the inductive load sensor attached to an electrical outlet, it should be understood that hard-wired connection to other loads could also benefit from this invention. Moreover, while the invention is disclosed in a building lighting system, which would typically operate under AC power, it should also be understood that the present invention can operate with DC power. Finally, the inductive load detection of this invention can be applied to applications other than dimmer circuits.

While a particular type of diode is disclosed for the elements 50 and 52, anything that can clamp a voltage up until a voltage limit is met can be utilized. Examples of other appropriate components include varistors, such as MOVs (metal oxide varistors).

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A circuit comprising:
an inductive load sensor which senses the presence of an inductive load at an electrical output by identifying a voltage spike, and a signal being sent when an inductive load is sensed.

2. The circuit as set forth in claim 1, wherein the inductive load sensor is part of dimmer circuit for providing an ability to dim the electrical output, the signal causing the dimmer circuit to stop dimming the electrical output.

3. The circuit as set forth in claim 2, wherein a line is provided parallel to the electrical output and includes elements that have a high impedance below a voltage limit, and are more conductive above the voltage limit.

4. The circuit as set forth in claim 3, wherein the elements are diodes.

5. The circuit as set forth in claim 4, wherein there are two diodes mounted in series on said line.

6. The circuit as set forth in claim 5, wherein a first of said diodes has a higher voltage limit than does a second.

7. The circuit as set forth in claim 6, wherein said second diode supplies a voltage downstream into a signal circuit when the total voltage limits of both said diodes are exceeded.

8. The circuit as set forth in claim 5, wherein said diodes are bi-directional zener diodes.

9. The circuit as set forth in claim 2, wherein the electrical output is an electrical outlet.

10. The circuit as set forth in claim 2, wherein the dimmer circuit operates with AC power.

11. A method of operating a lighting control circuit comprising the steps of:
providing a dimmer circuit, and dimming the power provided to an electrical outlet; and
sensing the presence of an inductive load in the electrical outlet by identifying a voltage spike and stopping dimming power when an inductive load is sensed.

12. The method as set forth in claim 11, wherein a line is provided parallel to the load and includes elements that have a high impedance below a voltage limit, and are conductive above the voltage limit.

13. A lighting control circuit comprising:
a plurality of input members for directing a user control signal to a controller;
said controller communicating with a dimmer circuit;
said dimmer circuit providing an ability to dim an electrical output based upon a request for such dimming by said user control signal; and
an inductive load sensor which senses the presence of an inductive load at the electrical load by identifying a voltage spike, and a signal being sent when an inductive load is sensed, the signal causing the dimmer circuit to stop dimming the electrical output.

14. The lighting control circuit as set forth in claim 13, wherein the electrical output is an electrical outlet.

15. The lighting control circuit as set forth in claim 14, wherein a line is provided parallel to the electrical outlet and includes elements that have a high impedance below a voltage limit, and are more conductive above the voltage limit.

16. The lighting control circuit as set forth in claim 15, wherein the elements are diodes.

17. The lighting control circuit as set forth in claim 16, wherein there are two diodes mounted in series on said line.

18. The lighting control circuit as set forth in claim 17, wherein a first of said diodes has a higher voltage limit than does a second.

19. The lighting control circuit as set forth in claim 18, wherein said second diode supplies a voltage downstream into a signal circuit when the total voltage limits of both said diodes are exceeded.

20. The lighting control circuit as set forth in claim 18, wherein said diodes are bi-directional zener diodes.

21. The lighting control circuit as set forth in claim 13, wherein said plurality of input members provide a wireless signal to a receiver, said receiver communicating with said controller.
